(19) United States
(12) Patent Application Publication
(10) Pub. No.: US 2013/0046066 A1
(43) Pub. Date: Feb. 21, 2013

(54) METHOD OF PREPARING A POLYMER AND COMPOSITIONS THEREFOR

(71) Applicants: Alan Thomas Cooper, Wingate (GB); Mark Dixon, Redcar (GB); Richard Michael Ward, Hartlepool (GB); James Brown, Redcar (GB)

(72) Inventors: Alan Thomas Cooper, Wingate (GB); Mark Dixon, Redcar (GB); Richard Michael Ward, Hartlepool (GB); James Brown, Redcar (GB)

(73) Assignee: JOHNSON MATTHEY PLC, London (GB)

(21) Appl. No.: 13/578,141

(22) PCT Filed: Jan. 19, 2011
(86) PCT No.: PCT/GB2011/050080

§ 371 Date: Oct. 31, 2012

(30) Foreign Application Priority Data
Feb. 11, 2010 (GB) 1002279.6

(51) Int. Cl. C08G 63/85; C08G 18/72; C08G 63/183; C08G 63/91; C08G 18/22

(52) U.S. Cl. 525/440.01; 528/279; 528/56

(57) ABSTRACT

The invention provides a method of making a polymer in the presence of a catalyst composition having an empirical formula M(glycerol)ₐ(X)_{b}, where M represents a metal atom selected from titanium, zirconium, hafnium or aluminium, X is a ligand derived from acetylacetone or a peroxo ion; a is a number between 1 and 2.5; b is a number in the range from 1 to 2. Reactive compositions containing the catalyst composition are also described.

The present invention relates to methods of preparing polymeric materials in the presence of novel compounds or compositions of titanium, zirconium, hafnium or aluminium with glycerol, and to compositions incorporating such novel compounds which are used to make polymeric materials.

Organic compounds of titanium, zirconium, hafnium and aluminium are well known for use as catalysts, e.g. for catalysing esterification and polyurethane reactions, cross-linkers, e.g. for coatings and well fracturing fluids, and as adhesion promoting compounds for printing inks. It is an object of the invention to provide a novel liquid compound which is stable in water.

According to the invention, we provide a method of making a polymer characterised in that the polymer or a precursor thereof is made in a reaction in which at least one reactive compound is reacted either with itself or with a different reactive compound in the presence of a catalyst composition having an empirical formula M(glycerol)ₐ(X)_{b}, where M represents a metal atom selected from titanium, zirconium, hafnium or aluminium, X is a ligand derived from acetylacetone or a peroxo ion; a is a number between 1 and 2.5; and b is a number in the range from 1 to 2.

According to a second aspect of the invention we provide a composition comprising at least one reactive compound, which is capable of forming a polymer by reacting either with itself or with a different reactive compound, and a catalyst comprising a composition resulting from the reaction of a compound of titanium, zirconium, hafnium or aluminium with
(a) glycerol and
(b) either:
   (i) acetylacetone or
   (ii) hydrogen peroxide, an inorganic base and water.

The resulting compositions containing the catalysts do not suffer from significant degradation of the catalyst in the presence of water because the catalysts are stable in the presence of water. Therefore when used in polyurethane manufacture, for example, a composition according to the invention containing a polyol as the reactive compound can be formulated with the catalyst even though such polyols may contain some moisture.

The method of the invention may be used to make a variety of polymers. Such polymers include polyesters and polyurethanes.

The reactive compound may be any that is capable of reacting either with itself or with a different reactive compound to form a polymer. The method and composition of the invention is of particular benefit when the reactive compound contains water or is likely to contain water or attract moisture, for example because it is hygroscopic or because the reactive compound will be reacted with a water-containing compound or used in a wet application. Examples of such reactive compounds include alcohols, particularly alcohols containing more than one hydroxyl group such as diols and triols; acids, particularly aliphatic and aromatic polybasic acids or esters of polybasic acids; and isocyanates, especially polyisocyanates.

Commonly used alcohols include aliphatic glycols such as 1,2-ethanedial (ethylene glycol), 1,3-propane diol (propylene glycol), 1,2-propane diol, 1,4-butanediol (butylene glycol), 1,6-hexanediol, pentaerythritol, neopentyl glycol, diethylene glycol and dipropylene glycol. These glycols may be used in the manufacture of various polymers such as polyesters, polyamides and polyurethanes. Another useful category of alcohols includes polyols such polyethylene glycol and polypropylene glycol, glycerol, diglycerol, trimethylol propane and others. Polyols may be formulated to have two or more than two hydroxyl groups. Naturally occurring oils such as castor oil, rape-seed oil, may be used. Polymeric polyols, i.e. compounds which have a polymeric structure and two or more reactive hydroxyl groups, are commonly used in polyurethane manufacture. The polymeric backbone structure may be selected to have various different formulations and molecular weights depending on the final application and desired physical and chemical properties of the finished polymer. Polyester polyols, polyether polyols, polyester-amide polyols, polythioetherpolyols, polycarbonate polyols, polyacetal polyols, polyolefin polyols and polysiloxane polyols, are examples of reactive compounds which may be used to make polyurethanes and are representative examples of polymeric polyols to be used in the present invention. Dispersions or solutions of addition or condensation polymers in polyols of the types described above may also be used; these are often referred to as “polymer” polyols. Mixtures of polyols, such as mixtures of di- and tri-functional materials optionally with lower molecular weight alcohols such as 1,4-butane diol may be used. Useful polyester polyols include polylactones, e.g. polycaprolactone, and those produced by reacting a dicarboxylic acid (which may be an aliphatic or aromatic dicarboxylic acid or anhydride) with an excess of a diol, for example, adipic acid with ethylene glycol or butanediol, terephthalic acid or anhydride with ethylene glycol or butane diol, or by reacting a lactone with an excess of a diol such as reacting caprolactone with propylene glycol. A very wide variety of polyols has been described in the prior art and is well known to the formulator of polymers and polymer systems for manufacturing polymers such as polyurethane materials.

In some applications, a urethane-containing material is formed by the reaction of an isocyanate, especially a polyisocyanate with a hydrated material such as lignocellulosic materials. This type of material is typically found in sheet-form building materials or moulded bodies such as waferboard, chipboard, fibreboard and plywood etc. The isocyanate compounds used as a binder in making such materials may be a reactive compound according to the present invention.

Polyesters can be produced by processes involving direct esterification or transesterification and a particularly preferred embodiment of the process of the invention is a polyesterification reaction in the presence of the catalyst described herein. In a polyesterification reaction aliphatic or aromatic polybasic acids or esters of polybasic acids are usually reacted with aliphatic or aromatic polyhydric alcohols to produce a polymeric ester, often via a diester intermediate product. Linear polyesters are produced from dibasic acids such as those mentioned hereinbefore or esters of said dibasic acids and dihydric alcohols. Alternatively, the preparation of polyesters may be achieved starting from an ester (typically a low alkyl ester) of a dicarboxylic acid, which may be e.g. a C₁-C₆ alkyl ester of any of the di- or poly-carboxylic acids mentioned above. Of these, methyl esters such as, in particular dimethyl terephthalate or dimethyl naphthalate, are preferred starting materials for the preparation of polyesters. Preferred polyesterification reactions according to the invention include the reaction of terephthalic acid or dimethyl terephthalate with 1,2-ethanediol (ethylene glycol) to produce polyethylene terephthalate (PET), with 1,3-propane diol to form polypropylene terephthalate (also known as poly(trimethylene)terephthalate or PTT), or with 1,4-butanediol (butylene glycol) to produce polybutylene terephthalate (PBT) or reaction of naphthalene dicarboxylic acid with 1,2-ethanediol to produce polyethylene naphthalate (PEN). Other glycols such as 1,6-hexanediol, and pentaerythritol are also suitable for preparing polyesters. Aliphatic or aromatic polybasic acids or esters of polybasic acids may be a reactive compound according to the present invention.

Polyurethanes are produced by processes involving the reaction of a polyisocyanate with a polyhydroxy compound such as a diol, triol or polyol (including polymeric polyols) of the type described above. Suitable polyisocyanates are well known and include organic polyisocyanate compounds and mixture of organic polyisocyanate compounds provided said compounds have at least 2 isocyanate groups. Organic polyisocyanates include diisocyanates, particularly aromatic diisocyanates, and isocyanates of higher functionality. Examples of suitable polyisocyanates include aliphatic isocyanates such as hexamethylene diisocyanate; and aromatic isocyanates such as m- and p-phenylene diisocyanate, tolylene-2,4- and tolylene-2,6-diisocyanate, diphenylmethane-4,4′-diisocyanate, chlorophenylene-2,4-diisocyanate, naphthylene-1, 5-diisocyanate, diphenylene-4,4′-diisocyanate, 4,4′-diisocyanate-3,3′-dimethyl-diphenyl, 3-methyldiphenylmethane-4,4′-di-isocyanate and diphenyl ether diisocyanate; and cycloaliphatic diisocyanates such as cyclohexane-2,4- and -2,3-diisocyanate, 1-methylcyclohexyl-2,4- and -2, 6-diisocyanate and mixtures thereof and bis-(isocyanatocyclohexyl)methane and triisocyanates such as 2,4,6-triisocyanatotoluene and 2,4,4-tri-isocyanatodiphenylether. Modified polyisocyanates containing isocyanurate, carbodiimide or uretonimine groups may also be used and are generally chosen when particular physical properties are desired. The organic polyisocyanate may also be an isocyanate-ended prepolymer made by reacting an excess of a diisocyanate or higher functionality polyisocyanate with a polyol such as, for example a polyether polyol or a polyester polyol. Preferably the polyisocyanate is liquid at room temperature. Suitable polyisocyanates are well known in the art.

Applications of such polyurethanes are very diverse and include mouldings, foams, adhesives, coatings, cast or spray elastomers, casting resins etc. The reaction of a polyisocyanate binder with hydrous materials such as those derived from wood or plant fibres, e.g. as used in the manufacture of composite boards for the construction industry is also an example of a reaction according to the invention.

In the formula M(glycerol)ₐ(X)_{b} we use (glycerol) to denote a ligand derived from glycerol, usually (CH₂OHCH(OH) CH₂O)⁻. In preferred compositions, a≧2. We have found that when at least 2 mols of glycerol-derived ligands are present per mole of metal the resulting composition is stable in water and can be dehydrated and then rehydrated to reform a stable aqueous solution. When less than 2 mols of glycerol-derived ligands are present per mole of metal then we have found the composition forms a stable solution in water but, if water is removed to dryness, a subsequent re-hydration is only partially successful. Excess glycerol may be present in the composition but it is unlikely to be bound to the metal centre, i.e. it would function as a diluent.

When X represents a ligand derived from acetylacetone, b=2 when the formula is stoichiometric. b may be greater than 2 in an empirical formula when the composition includes an excess of the acetylacetone, which would serve as a diluent in the composition. When X represents a ligand derived from a peroxo ion, b=1 when the formula is stoichiometric because each peroxo ion has a charge of −2. If excess peroxide is added then it decomposes to form oxygen. The composition may be prepared using an excess of hydrogen peroxide. An appropriate amount of the added peroxide forms a peroxide ion and binds to the metal centre whilst the remainder decomposes.

The metal M is selected from any metal capable of forming a covalent metal-oxygen bond. Particularly preferred metals include titanium and zirconium, especially titanium. Suitable metal compounds include metal halides, metal alkoxides, metal halo-alkoxides, metal carboxylates and mixtures of these compounds. Typical alkoxides have the general formula M(OR)_{y} in which M is Ti, Zr, Hf, or Al, y is the oxidation state of the metal, i.e. 3 or 4, and R is a substituted or unsubstituted, cyclic or linear, alkyl, alkenyl, aryl or alkyl-aryl group or mixtures thereof. Preferably, R contains up to 8 carbon atoms and, more preferably, up to 6 carbon atoms. Generally, all OR groups are identical but alkoxides derived from a mixture of alcohols can be used and mixtures of alkoxides can be employed when more than one metal is present in the complex. When the metal is titanium, preferred titanium compounds include titanium alkoxides having a general formula Ti(OR)₄ in which R is an alkyl group, preferably having from 1 to 8 carbon atoms and each R group may be the same as or different from the other R groups. Particularly suitable metal compounds include titanium tetrachloride, titanium tetra-isopropoxide, titanium tetra-n-propoxide, titanium tetra-n-butoxide, titanium tetraethoxide (tetraethyl titanate), zirconium n-propoxide, zirconium butoxide, hafnium butoxide, aluminium sec-butoxide, aluminium trichloride, aluminium trimethoxide, aluminium triethoxide, aluminium tri-isopropoxide and aluminium tri-n-propoxide.

The inorganic base is preferably an alkali metal, alkaline earth metal or ammonium hydroxide. The function of the base is to deprotonate the hydrogen peroxide ligand allowing it to bond more easily as O₂². Therefore other bases may be suitable so long as they are able to function in this way. Preferred bases include sodium hydroxide, potassium hydroxide and ammonium hydroxide. The amount of base present is preferably sufficient to provide at least 0.5 moles of cation (e.g. Na⁺, K⁺ or NH₄⁺) per mole of metal M. When M is titanium and the base is sodium hydroxide, we have found that when at least 0.56 moles of sodium are present per mole of titanium, the resulting composition forms a stable aqueous solution which yields a crystalline solid on drying, the solid being capable of being re-dissolved in water. We have found that when 2 or more moles of base are present per mole of metal, then the composition is less stable in water, particularly when heated.

The catalyst compounds are preferably made by first reacting together the metal compound and the reactants (b), i.e. either the acetylacetone or the hydrogen peroxide, inorganic base and water, followed by reaction of the resulting mixture with the glycerol.

The catalysts used in the invention may be supplied neat (particularly when the composition is, itself a liquid) or supplied as a formulated composition containing a solvent or diluent, which may be present in quantities representing up to 90% of the weight of the total catalyst composition (i.e. including the diluent), more preferably up to 50% by weight. The solvent or diluent may comprise water, an alcohol, diol or polyol, another protic solvent or a glycerol-based oil, especially naturally derived oils such as castor oil, rape-seed oil etc. Any other diluent which is miscible with the polyol, polyisocyanate or prepolymer used in the polyurethane formulation may be used. In some formulations, it is preferred to use as a diluent a liquid component which is already present in or which is compatible with the polyurethane reaction components, such as a diol or polyol which may function as a chain extender e.g. 1,4-butane diol or diethylene glycol. Preferred diluents include 1,3-propanediol, 1,4-butanediol, diethylene glycol, glycerol, and natural oils such as castor oil and rape-seed oil.

The catalyst compositions and their use in reactions to make polymeric compounds will be described in the following non-limiting examples.

### EXAMPLE 1

### Ti(glycerol)₂(acac)₂·4(ⁱPrOH)

Acetylacetone (353 mg, 3.52 mmol) was added to 500 mg (1.76) mmol of tetraisopropyl titanate (VERTEC™ TIPT available from Johnson Matthey PLC—hereinafter “TIPT”) with stirring. The reaction was exothermic and resulted in a clear yellow/red solution. Glycerol (324 mg, 3.52 mmol) was added to the solution to give a clear yellow solution. This product remained as a mobile, clear liquid even upon heating at 50° C. for 1 hour. The product described above was dissolved into water as a 10 w/w % solution, to give a clear yellow solution. The aqueous solution remained unchanged for greater than 3 months at ambient temperature. The aqueous solution was heated at 60° C. for 1 hour, to give a hazy solution, suggesting hydrolysis of the titanium complex had occurred.

### EXAMPLE 2

### Ti(glycerol)₂(acac)₂

Acetylacetone (353 mg, 3.52 mmol) was added to TIPT (500 mg, 1.76 mmol) with stirring. The reaction was exothermic and resulted in a clear yellow/red solution. Glycerol (324 mg, 3.52 mmol) was added to the solution to give a clear yellow solution. The product was distilled at 80° C., under reduced pressure to remove the isopropanol resulting in a highly viscous, clear liquid (760 mg). The product was dissolved in water as a 10 w/w % solution, to give a clear yellow solution and also a yellow precipitate. The yellow precipitate dissolved upon further addition of water (approximately 1 w/w % aqueous solution). The aqueous solution remained unchanged for greater than 3 months at ambient temperature. The aqueous solution was heated at 60° C. for 1 hour, to give a hazy solution, suggesting that hydrolysis of the titanium complex had occurred.

### EXAMPLE 3

### [Ti(O₂)(glycerol)₂][NH₄]

500 mg TIPT (1.76 mmol) was dissolved into a clear, colourless solution consisting of aqueous hydrogen peroxide (684 mg, 7.04 mmol, 35 wt %), aqueous ammonia (224 mg, 5.28 mmol, 33 wt % solution) and water (10 g). A clear yellow solution was formed. Aqueous glycerol (1.296 g, 3.52 mmol, 25 wt % solution) was added to the reaction mixture and stirred for 30 minutes, resulting in a clear yellow solution. The solution was then heated at 80° C. for 5 minutes to decompose any remaining hydrogen peroxide. This solution was shown to not change in colour, viscosity or clarity for a time period greater than 12 weeks.

### EXAMPLE 4

The complex formed in Example 3 was evaporated to dryness at 80° C., under reduced pressure, resulting in a yellow solid. A yellow transparent aqueous solution having a neutral pH reading (pH=7±0.5) was prepared by adding distilled water to the solids. The solution was again evaporated to dryness and then reformed by adding distilled water to the dry yellow solid.

### EXAMPLE 5

### Ti:Glycerol:Peroxo:NH₄=1:1:4:3

TIPT (500 mg, 1.76 mmol) was dissolved into a clear, colourless solution consisting of aqueous hydrogen peroxide (684 mg, 7.04 mmol, 35 wt %), aqueous ammonia (224 mg, 5.28 mmol, 33 wt %) and water (10 g). A clear yellow solution was formed. Aqueous glycerol (648 mg, 1.76 mmol, 25 wt %) was added to the reaction mixture and stirred for 30 minutes, resulting in a clear yellow solution. The solution was then heated at 80° C. for 5 minutes to decompose any remaining hydrogen peroxide leaving a clear yellow solution that remained stable for more than 3 days.

### EXAMPLE 6

### Ti:Glycerol:Peroxo:Na=1:2:4:2

TIPT (500 mg, 1.76 mmol) was dissolved into a clear, colourless solution consisting of aqueous hydrogen peroxide (684 mg, 7.04 mmol, 35 wt %), aqueous sodium hydroxide (440 mg, 3.52 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution became hazy when the water was removed at 80° C., under reduced pressure. The solution measured pH 11.

### EXAMPLE 7

### Ti:Glycerol:Peroxo:Na=1:2:4:1 (Na[Ti(O—O)(Glycerol)₂])

TIPT (500 mg, 1.76 mmol) was dissolved into a clear, colourless solution consisting of aqueous hydrogen peroxide (684 mg, 7.04 mmol, 35 wt %), aqueous sodium hydroxide (220 mg, 1.76 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution remained unchanged with respect to colour and clarity when the water was removed at 80° C., under reduced pressure. Complete removal of water resulted in a yellow solid, which readily re-dissolved in water to provide a clear yellow solution of pH 11.

### EXAMPLE 8

### Ti:Glycerol:Peroxo:Na=1:2:4:0.56

TIPT (500 mg, 1.76 mmol) was dissolved into a clear, colourless solution consisting of aqueous hydrogen peroxide (684 mg, 7.04 mmol, 35 wt %), aqueous sodium hydroxide (123 mg, 0.98 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution remained unchanged with respect to colour and clarity when the water was removed at 80° C., under reduced pressure. Complete removal of water resulted in a yellow solid, which readily re-dissolved in water to provide a clear yellow solution having a measured pH of 8. Likely structure: [Ti(O₂)(glycerol)₂][Na]_{0.56}. This composition may also be represented as 0.56 Na[Ti(O—O)(glycerol)₂]+0.44 Ti(O—O)(glycerol)₂, i.e. as a mixture.

### EXAMPLE 9

### Ti:Glycerol:Peroxo:Na=1:2:4:0.55

TIPT (500 mg, 1.76 mmol) was dissolved into a clear, colourless solution consisting of aqueous hydrogen peroxide (684 mg, 7.04 mmol, 35 wt %), aqueous sodium hydroxide (121 mg, 0.97 mmol, 32 wt %) and water (10 g). A clear yellow solution was formed. Aqueous glycerol (1.296 g, 3.52 mmol, 25 wt %) was added to the reaction mixture and stirred for 30 minutes, resulting in a clear yellow solution. The solution was then heated at 80° C. for 5 minutes to decompose any remaining hydrogen peroxide. This solution became hazy during heating.

### EXAMPLE 10

### Preparation of Polyester

A catalyst solution was formed by making an aqueous solution of [Ti(O₂)(glycerol)₂][Na]_{0.56}, as prepared in Example 8, at a concentration to give a total Ti concentration in the solution of 2.1 wt. %.

The catalyst solution was used to prepare a polyester. Ethylene glycol was mixed with a mixture of terephthalic acid (98 wt %) and isophthalic acid (2 wt %) in an autoclave, the mol ratio of ethylene glycol:phthalic acids being 1.2. Sufficient catalyst solution was added in ethylene glycol to provide a titanium concentration of 7 ppm in the polyester. The mixture was reacted at a temperature of 260° C. and a pressure of 40 psig (276 MPa) in a conventional esterification procedure, wherein water was continuously removed from the reaction mixture, to form bishydroxyethyl terephthalate. The “DE time”, i.e. time to complete the direct esterification reaction (when water was no longer produced) was 89 minutes. The resulting monomer was then polycondensed at a temperature of 290° C. and under vacuum (<1 mbar (<100 Pa)) with the removal of ethylene glycol as is conventional. The time taken to attain an intrinsic viscosity (IV) of 0.62, “PC time”, was 112 minutes. The polymer was removed from the reactor and cut into chips. Intrinsic viscosity values are calculated from solution viscosity measurements by extrapolation to zero concentration. The measurements are determined using as solvent a mixture of 60% (by weight) phenol and 40% tetrachloroethane (3:2 PTCE) at 30 ° C. The method follows ISO 1628-5:1998.

The colour was measured using Hunter b-value is obtained using the method of ASTM D6290-05 “Standard Test Method for Color Determination of Plastic Pellets”. The method employed uses a BYK COLORVIEW instrument which provides the reading of b-value according to the Hunter scale directly. The colour is shown in the table below.

### EXAMPLE 11

### Preparation of Polyester

Example 10 was repeated but the polycondensation was continued until an IV of 0.75 had been attained and the PC time is the time to reach this IV. The results are shown in the table.

| | DE time | PC time | | | |
|---|---|---|---|---|---|
| Example | (mins) | (mins) | L* | a* | b* |
| 10 | 89 | 112 | 74.33 | −2.69 | 9.1 |
| 11 | 85 | 150 | 75.7 | −3.09 | 14.9 |

### EXAMPLE 12

### Preparation of Polyurethane Elastomer With Polyester Polyol

A 50 wt. % solution of Ti(acac)₂(glycerol)₂ in diethylene glycol was used as a catalyst in the following polyurethane elastomer system:

Polyester polyol: Diorez™ PR3: 48.94 g

Chain extender: 1,4-butane diol (1,4-BDO): 5.44 g

Isocyanate: Diprane™ 53 (Dow): 45.62 g

DIOREZ and DIPRANE are trademarks of Dow Hyperlast.

The polyester polyol was mixed with the chain extender and the mixture was dried at 90° C. under vacuum and allowed to equilibrate for 12 hours before use. The catalyst (0.054 g) was added to the mixture of polyol and chain extender (at 40° C.) to provide a concentration of 0.1 wt. % (based on total weight of polyol and chain extender) and mixed on a centrifugal mixer for 30 seconds. The isocyanate (at 40° C.) was then added to the polyol/catalyst mixture and mixed on a centrifugal mixer for 30 seconds. The mixture was poured into a disposable metal pot and the gel-time was recorded using a Gardco gel timer with the heated mould set at 80° C. The gel time was measured as 288 seconds.

### EXAMPLE 13

### Preparation of Polyurethane Elastomer with Polyether Polyol

A 50 wt. % solution of Ti(acac)₂(glycerol)₂ in diethylene glycol was used as a catalyst in the following polyurethane elastomer system:

Polyol 1: polypropylene glycol (PPG) 4.8K triol: 27.0 g

Polyol 2: Voranol™ EP1900: 27.0 g

Chain extender: 1,4-BDO: 6.01 g

Isocyanate: 90: 10 Lupranate™ MP102: Lupranate MM103: 29.9 g

VORANOL is a trademark of the Dow Chemical Company. LUPRANATE is a trademark of BASF.

The catalyst (0.03 g) was added to the mixture of polyols and chain extender at room temperature, to provide a concentration of 0.05 wt. % (based on the total weight of polyol and chain extender) and mixed on a centrifugal mixer for 30 seconds. The room temperature isocyanate was then added to the polyol/catalyst mixture and mixed on a centrifugal mixer for 30 seconds. The mixture was poured into a disposable paper pot and the gel-time was recorded at room temperature using a Gardco gel timer. The gel time was measured as 250 seconds.

### EXAMPLE 14

### Preparation of Polyurethane Elastomer with Castor Oil/PPG.

A 50 wt. % solution of Ti(acac)₂(glycerol)₂ in diethylene glycol was used as a catalyst in the following polyurethane elastomer system using as a polyol a 90:10 castor oil:PPG formulation:

Polyol 1: castor oil: 50.0 g

Polyol 2: PPG 2K diol: 5.60 g

Isocyanate: Diprane™ 5046: 24.5 g

The procedure described in Example 13 was followed, using 0.278 g of catalyst to provide a concentration of 0.05 wt. % catalyst (based on the polyol and castor oil). The gel time was measured as 815 seconds.

1. A method of making a polymer, wherein the polymer or a precursor thereof is made in a reaction in which at least one reactive compound is reacted either with itself or with a different reactive compound in the presence of a catalyst composition having an empirical formula M(glycerol)ₐ(X)_{b}, where M represents a metal atom selected from the group consisting of titanium, zirconium, hafnium and aluminium, X is a ligand derived from acetylacetone or a peroxo ion; a is a number between 1 and 2.5; and b is a number in the range from 1 to 2.

2. The method as claimed in claim 1, wherein said reactive compound comprises a compound selected from the classes of compounds consisting of alcohols, aliphatic or aromatic diols, aliphatic or aromatic triols, polyols and polymeric polyols, naturally occurring oils, polycarboxylic acids, an ester of a polycarboxylic acid, aliphatic or aromatic carboxylic acids containing a hydroxyl or amine functional group, a lactone, lactide and polyisocyanates.

3. The method according to claim 2, wherein said reactive compound comprises a compound selected from the group consisting of 1,2-ethanediol, 1,3-propanediol, 1,2-propanediol, 1,4-butanediol, 1,6-hexanediol, pentaerythritol, neopentyl glycol, diethylene glycol, dipropylene glycol, polyethylene glycol, polypropylene glycol, glycerol, diglycerol, trimethylol propane, polyester polyols, polyether polyols, polyester-amide polyols, polythioetherpolyols, polycarbonate polyols, polyacetal polyols, polyolefin polyols, polysiloxane polyols, castor oil, rape-seed oil, a dispersion or solution of addition or condensation polymers in a polyol, polylactones, a polyol produced by reacting a dicarboxylic acid with an excess of a diol, phthalic acids, esters of phthalic acids and organic polyisocyanates.

4. The method according to claim 1, wherein said catalyst composition is added to said reaction in the form of an aqueous solution.

5. The method according to claim 1, wherein said catalyst composition is added to said reaction in the form of a dry solid.

6. The method according to claim 1, wherein said catalyst composition comprises a compound of formula M(glycerol)₂(peroxo)₁.

7. The method according to claim 1, wherein said catalyst composition comprises a compound of formula M(glycerol)₂(peroxo)₁[A]_{0.56-2} where A is selected from sodium, potassium and ammonium.

8. The method according to claim 1, wherein said catalyst composition comprises a compound of formula M(glycerol)₂(acetylacetonato)₂, where M represents a metal atom selected from the group consisting of titanium, zirconium and hafnium.

9. The method according to claim 1, wherein said catalyst composition comprises a compound of formula M(glycerol)₂(acetylacetonato)₁, where M represents an aluminium atom.

10. The method according to claim 1, wherein said catalyst composition comprises free acetylacetone.

11. The method according to claim 1, wherein said catalyst composition comprises free glycerol.

12. The method according to claim 1 for making a polyurethane or a polyester.

13. A composition comprising at least one reactive compound, which is capable of forming a polymer by reacting either with itself or with a different reactive compound, and a catalyst composition having an empirical formula M(glycerol)ₐ(X)_{b}, where M represents a metal atom selected from the group consisting of titanium, zirconium, hafnium and aluminium, X is a ligand derived from acetylacetone or a peroxo ion; a is a number between 1 and 2.5; and b is a number in the range from 1 to 2.

14. The composition according to claim 13, wherein said catalyst composition comprises a compound of formula M(glycerol)₂(peroxo)₁.

15. The composition according to claim 13, wherein said catalyst composition comprises a compound of formula M(glycerol)₂(peroxo)₁[A]_{0.56-2} where A is selected from sodium, potassium and ammonium.

16. The composition according to claim 13, wherein said catalyst composition comprises a compound of formula M(glycerol)₂(acetylacetonato)₂, where M represents a metal atom selected from the group consisting of titanium, zirconium and hafnium.

17. The composition according to claim 13, wherein said catalyst composition comprises a compound of formula M(glycerol)₂(acetylacetonato)₁, where M represents an aluminium atom.

18. The composition according to claim 16, wherein said catalyst composition comprises free acetylacetone.

19. The composition according to claim 13, wherein said catalyst composition comprises free glycerol.

20. The composition according to claim 13, wherein said reactive compound comprises a compound selected from the classes of compounds consisting of alcohols, aliphatic or aromatic diols, aliphatic or aromatic triols, polyols and polymeric polyols and polyisocyanates.

21. The composition according to claim 20, wherein said reactive compound comprises a compound selected from the group consisting of 1,2-ethanediol, 1,3-propanediol, 1,2-propanediol, 1,4-butanediol, 1,6-hexanediol, pentaerythritol, neopentyl glycol, diethylene glycol, dipropylene glycol, polyethylene glycol, polypropylene glycol, glycerol, diglycerol, trimethylol propane, polyester polyols, polyether polyols, polyester-amide polyols, polythioetherpolyols, polycarbonate polyols, polyacetal polyols, polyolefin polyols, polysiloxane polyols, a dispersion or solution of addition or condensation polymers in a polyol, polylactones, a polyol produced by reacting a dicarboxylic acid with an excess of a diol and organic polyisocyanates.

22. The composition according to claim 17, wherein said catalyst composition comprises free acetylacetone.
